(19) United States
(12) Patent Application Publication
(10) Pub. No.: US 2015/0253932 A1
(43) Pub. Date: Sep. 10, 2015

(54) INFORMATION PROCESSING APPARATUS, INFORMATION PROCESSING SYSTEM AND INFORMATION PROCESSING METHOD

(71) Applicant: Fumihiko INOUE, Kyoto (JP)

(72) Inventors: Fumihiko INOUE, Kyoto (JP); Keisuke SEKO, Kyoto (JP)

(21) Appl. No.: 14/631,167

(22) Filed: Feb. 25, 2015

(30) Foreign Application Priority Data
Mar. 10, 2014 (JP) 2014-046504

(51) Int. Cl. G06F 3/042; G06F 1/16

(52) U.S. Cl. CPC G06F 3/0425; G06F 1/1692

(57) ABSTRACT

An example system includes a housing having at least one surface provided with a display, a linear image sensor located, facing outside the housing, at a side part or a corner part of the housing when the surface provided with the display is viewed as a front surface, and an information processing unit performing information processing based on an image obtained by the linear image sensor.

### CROSS-REFERENCE TO RELATED APPLICATIONS

This application is based upon and claims the benefit of priority of the prior Japanese Patent Application No. 2014-046504, filed on Mar. 10, 2014, the entire contents of which are incorporated herein by reference.

### FIELD

The present technology herein relates to an information processing apparatus, an handheld information processing apparatus, an information processing system and an information processing method utilizing a linear image sensor, an image sensor, an optical sensor or the like.

### BACKGROUND AND SUMMARY

In recent years, an information processing apparatus which can be carried by a user, such as a mobile phone, a smartphone, a tablet terminal device or a portable game device, has widely been spread. In such an information processing apparatus, a touch panel or the like is mounted to enhance the operability of a user, since a large input device such as a keyboard cannot easily be mounted thereto.

According to an aspect of the embodiment, an information processing apparatus includes a housing having at least one surface provided with a display, a linear image sensor located, facing outside the housing, at a side part or a corner part of the housing when the surface provided with the display is viewed as the front surface, and an information processing unit performing information processing based on an image obtained by the linear image sensor.

The object and advantages of the present technology herein will be realized and attained by means of the elements and combinations particularly pointed out in the claims. It is to be understood that both the foregoing general description and the following detailed description are exemplary and explanatory and are not restrictive of the technology herein.

The above and further objects and features of the present technology herein will more fully be apparent from the following detailed description with reference to the accompanying drawings.

### BRIEF DESCRIPTION OF THE DRAWINGS

FIG. 1 shows an example non-limiting schematic view illustrating an outer appearance of a game apparatus according to a present example embodiment;

FIG. 2 shows an example non-limiting block diagram illustrating a configuration of a game apparatus according to the present example embodiment;

FIG. 3 shows an example non-limiting schematic view for illustrating a space pointer function of a game apparatus;

FIG. 4 shows an example non-limiting flowchart illustrating a procedure of processing for a space pointer function performed by a game apparatus;

FIG. 5 shows an example non-limiting schematic view for illustrating an additional interface function of a game apparatus;

FIG. 6 shows an example non-limiting flowchart illustrating a procedure of processing for the additional interface function performed by a game apparatus;

FIG. 7 shows an example non-limiting schematic view for illustrating a side surface touching operation in a game apparatus;

FIG. 8 shows an example non-limiting schematic view for illustrating a figure detecting function of a game apparatus;

FIG. 9 shows an example non-limiting flowchart illustrating a procedure of processing for a figure detecting function performed by a game apparatus;

FIG. 10 shows an example non-limiting schematic view for illustrating an additional operation device for a game apparatus;

FIG. 11 shows an example non-limiting flowchart illustrating a procedure of processing related to an additional operation device performed by a game apparatus;

FIG. 12 shows an example non-limiting schematic view for illustrating a use mode determining function of a game apparatus;

FIG. 13 shows an example non-limiting flowchart illustrating a procedure of use mode determination processing performed by a game apparatus;

FIG. 14 shows an example non-limiting flowchart illustrating a procedure of pulse detection processing performed by a game apparatus;

FIG. 15 shows an example non-limiting schematic view for illustrating a function of a game apparatus for detecting a different apparatus; and

FIG. 16 shows an example non-limiting flowchart illustrating a procedure of processing for detecting a different apparatus performed by a game apparatus.

### DETAILED DESCRIPTION OF NON-LIMITING EXAMPLE EMBODIMENTS

### <Hardware Configuration>

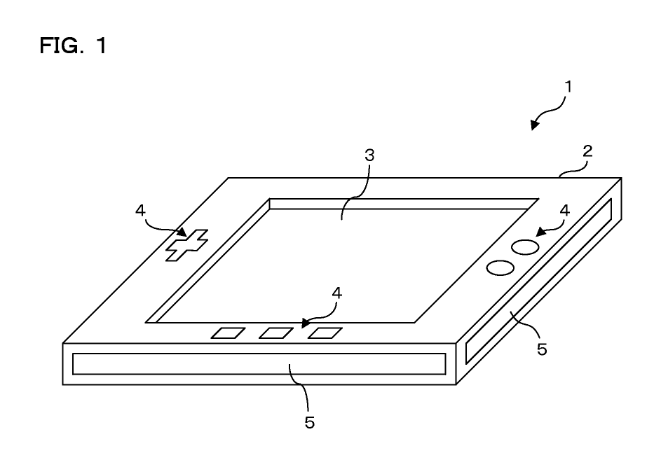

FIG. 1 shows an example non-limiting schematic view illustrating an outer appearance of a game apparatus according to a present example embodiment. A game apparatus 1 according to the present example embodiment is a handheld, portable or mobile apparatus. The game apparatus 1 has a size and weight for a user to carry it with a hand. The game apparatus 1 includes a housing 2 having the shape of a flat rectangular parallelepiped (or rectangular plate). One of two wide surfaced in the housing 2 is provided with a display 3 at substantially the middle thereof. The surface on which the display 3 is located is referred to as a front surface. On the front surface of the housing 2, an operation unit 4 is located at a frame-like portion surrounding the display 3. The operation unit 4 includes a cross key, a push button and the like that are appropriately arranged thereon.

In the game apparatus 1 according to the present example embodiment, a linear image sensor 5 is disposed at each of four side parts (side surfaces) of the housing 2 so as to face outward. That is, the linear image sensor 5 is located at each of the side parts of the housing 2 when the surface provided with the display 3 is viewed as the front surface. Moreover, the linear image sensor 5 is oriented in the direction along the surface provided with the display surface 3. Though only two linear image sensors 5 are illustrated in FIG. 1, the game apparatus 1 includes four linear image sensors 5. Each side surface of the housing 2 has a substantially rectangular elongated shape. Each linear image sensor 5 has a long linear or rectangular shape, and is arranged in the longitudinal direction of each side surface. The linear image sensor 5 is an imaging device which utilizes a CCD (Charge Coupled Device), a CMOS (Complementary Metal Oxide Semiconductor) or the like. The linear image sensor 5 is a device used for reading a document, for example, in a scanner or the like. The linear image sensor 5 is also referred to as, for example, a line image sensor, a one-dimensional image sensor or the like.

Each linear image sensor 5 obtains an image by taking an image of a side of the housing 2. The image to be obtained by each linear image sensor 5 is a linear or rectangular image including one to several pixels on the short side and several hundred pixels to several tens of thousands of pixels on the long side. In the case where the game apparatus 1 is placed on, for example, a horizontal desk, each linear image sensor 5 takes an image in the direction along the desk surface from a side surface of the housing 2 outward, to obtain a linear or rectangular image.

In the present example embodiment, the linear image sensor 5 takes an image by an imaging method in which objects in a foreground to a background, i.e. from short distance to long distance, are all in focus, which is a so-called deep focus. Therefore, though not illustrated, an optical member or optical members such as a lens and/or a diaphragm is/are provided to enable deep focus imaging.

In the present example embodiment, the linear image sensor 5 receives infrared light to take an image. Thus, though not illustrated, the linear image sensor 5 is provided with an optical filter or the like for transmitting infrared light therethrough and blocking light other than infrared light. The optical filter may be located, for example, on a surface of a CCD or CMOS, or lens for the deep focus imaging described above.

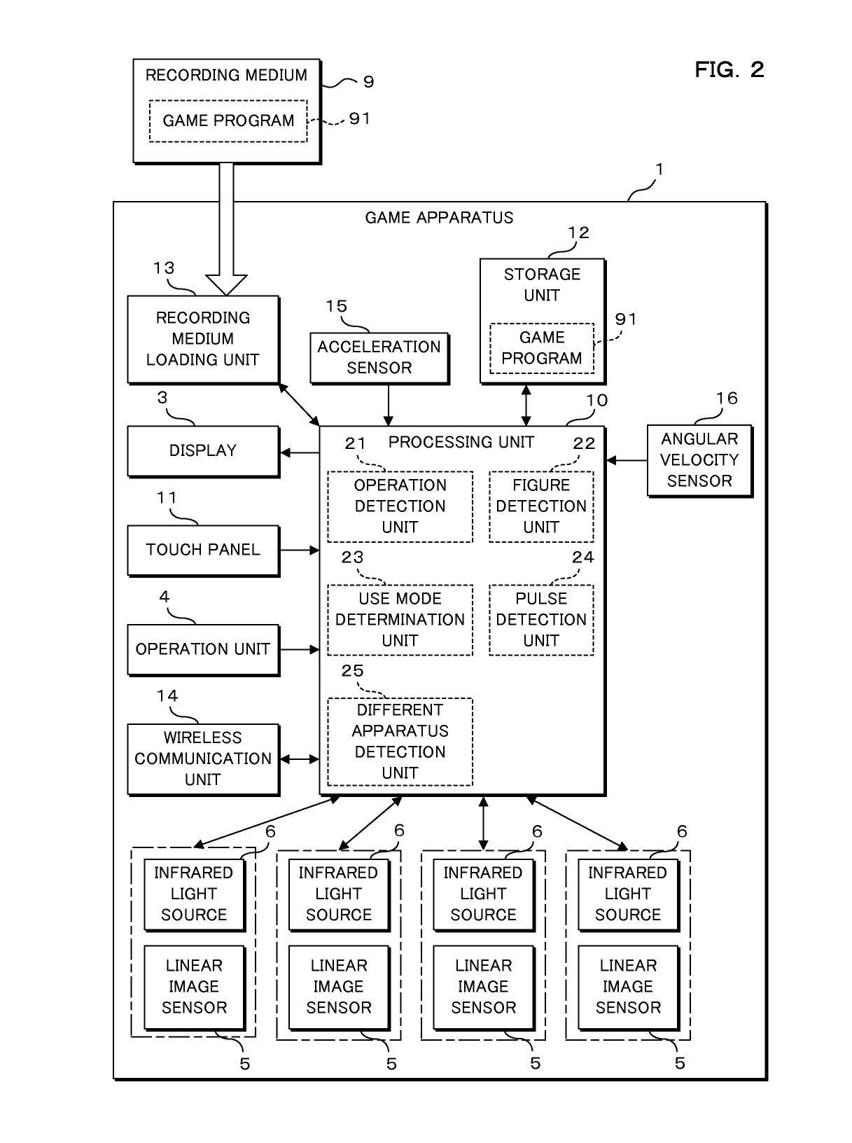

Though not illustrated in FIG. 1, the game apparatus 1 according to the present example embodiment includes a light source for emitting infrared light. The light source is illustrated as an infrared light source 6 in FIG. 2. The infrared light source 6 is placed on each of the side surfaces of the housing 2 near each linear image sensor 5. For example, the infrared light source 6 may be linearly arranged to be in substantially parallel with each linear image sensor 5. For example, infrared light sources 6 may be linearly arranged respectively at both ends of each linear image sensor 5. Each infrared light source 6 emits infrared light from a side surface of the housing 2 to the outside. The game apparatus 1 emits infrared light from the infrared light source 6 when the linear image sensor 5 takes an image. In the game apparatus 1, the linear image sensor 5 can receive reflection light, which is obtained by reflecting the infrared light from the infrared light source 6 on an object present at a side of the housing 2, to take an image with infrared light.

The game apparatus 1 according to the present example embodiment uses linear image sensors 5 located at four sides of the housing 2 to provide a new function not offered by an existing game apparatus. For example, the game apparatus 1 can determine an operation by the user performed at a peripheral region of the housing 2 based on an image obtained by the linear image sensor 5, and to accept such operation as an operation for a game. The game apparatus 1 can determine an operation such as making contact with or approaching a side surface of the housing 2 based on an image obtained by the linear image sensor 5, to utilize the linear image sensor 5 in place of a touch panel. The game apparatus 1 can perform information processing such as a game based on both of the operation of the user determined by the linear image sensor 5 and the operation of the user sensed by the operation unit 4, touch panel or the like. For example, the game apparatus 1 is able to detect an object such as a figure placed in a peripheral region of the housing 2 based on an image obtained by the linear image sensor 5 and to reflect the type or the like of the detected object in the game processing.

When, for example, the user is holding the housing while using the game apparatus 1, the game apparatus 1 detects the position of the housing 2 where the user is holding. Based on the result of detection, the game apparatus 1 may determine, for example, the mode of use or the way of holding the game apparatus 1 by the user to reflect it in the game processing or other information processing. The game apparatus 1 may detect a pulse of the user based on the infrared light reflected by a hand or the like of the user who is holding the housing 2. The game apparatus 1 determines a relative position, orientation and the like with respect to a different game apparatus 1 having a similar configuration based on an image obtained by receiving, at its own linear image sensor 5, infrared light emitted from the infrared light source 6 included in the different game apparatus 1. The game apparatus 1 may reflect the result of determination in the communication processing with the different game apparatus 1.

FIG. 2 shows an example non-limiting block diagram illustrating the configuration of the game apparatus 1 according to the present example embodiment. As described above, the game apparatus 1 according to the present example embodiment includes a display 3, an operation unit 4, a linear image sensor 5, an infrared light source 6 and the like. The game apparatus 1 includes, in the housing 2, a processing unit (processor) 10, a touch panel 11, a storage unit 12, a recording medium loading unit 13, a wireless communication unit 14, an acceleration sensor 15, an angular velocity sensor 16 and the like. The processing unit 10 of the game apparatus 1 is configured by using an arithmetic processing device such as a CPU (Central Processing Unit). The processing unit 10 reads out and executes a game program 91 stored in the storage unit 12 or a game program 91 recorded in a recording medium 9 loaded in the recording medium loading unit 13, to perform various kinds of information processing related to a game. For example, the processing unit 10 performs processing of accepting an operation performed on the operation unit 4 or touch panel 11. The processing unit 10 performs processing such as determination of a game in accordance with the accepted operation. The processing unit 10 performs processing of generating a game image displayed on the display 3 in accordance with the accepted operation, an event in a game, or the like. The processing unit 10 performs processing for implementing the functions described above using the linear image sensor 5.

The display 3 is configured with a liquid-crystal panel or the like, which displays an image supplied from the processing unit 10. The operation unit 4 is formed by appropriately combining, for example, a cross key, push buttons and the like. The operation unit 4 notifies the processing unit 10 of the details of operation performed by the user, such as pressing down or releasing of a button, for example. The storage unit 12 is configured using a non-volatile semiconductor memory, a hard disk or the like. The storage unit 12 can store a program such as a game program 91 as well as various kinds of data. The recording medium loading unit 13 is configured to load or remove a recording medium 9 of a card type, cassette type, disk type or the like thereto or therefrom. The processing unit 10 can read out the game program 91 and various kinds of data from the recording medium 9 loaded to the recording medium loading unit 13.

The wireless communication unit 14 transmits/receives data to/from a server apparatus, a different game apparatus 1 or the like via a network such as a mobile telephone network or a wireless LAN (Local Area Network). For example, the game apparatus 1 can download the game program 91 or the like through communication with the server apparatus at the wireless communication unit 14, and store it in the storage unit 12. The acceleration sensor 15 senses an acceleration applied to the game apparatus 1 and notifies the processing unit 10 thereof. The angular velocity sensor 16 senses an angular velocity of the game apparatus 1 and notifies the processing unit 10 thereof. Accordingly, the processing unit 10 can determine, for example, the orientation of the housing 2, based on the gravitational acceleration and/or angular velocity applied to the game apparatus 1.

In the game apparatus 1 according to the present example embodiment, the processing unit 10 executes the game program 91 to implement an operation detection unit 21, a figure detection unit 22, a use mode determination unit 23, a pulse detection unit 24, a different apparatus detection unit 25 and the like as software function blocks. These function blocks are for implementing the functions as described above using the linear image sensor 5. While these function blocks are implemented by the game program 91 in the present example embodiment, these may also be implemented by, for example, an operating system or an application program other than games. Furthermore, it is not necessary for all these function blocks to be implemented by one game program 91. It is, for example, possible to implement some of these function blocks by the processing unit 10 implementing the game program 91.

The operation detection unit 21 of the processing unit 10 performs processing of detecting an operation of the user performed at the side of the housing 2 of the game apparatus 1, based on the image obtained by the linear image sensor 5. The operation detection unit 21 performs processing of detecting an operation such as making contact with or approaching a side surface of the housing 2, based on the image obtained by the linear image sensor 5. The figure detection unit 22 performs processing of detecting a figure for a game placed at the side of the housing 2, based on the image obtained by the linear image sensor 5. The figure detection unit 22 detects the type, position, orientation and the like of a figure. The use mode determination unit 23 performs processing of determining a mode of use (also referred to as “use mode”) of the game apparatus 1, based on the image obtained by the linear image sensor 5, the acceleration sensed by the acceleration sensor 15 and the angular velocity sensed by the angular velocity sensor 16. The use mode determination unit 23 determines whether the housing 2 of the game apparatus 1 is used vertically or horizontally, and which part of the housing 2 the user is holding during use. The pulse detection unit 24 performs processing of detecting the user's pulse based on the image taken by the linear image sensor 5 receiving reflection light obtained when the hand of the user holding the housing 2 reflects the infrared light from the infrared light source 6. The different apparatus detection unit 25 performs processing of determining the position, orientation and the like of a different game apparatus 1, based on the image taken by the linear image sensor 5 receiving infrared light emitted from the infrared light source 6 of the different game apparatus 1.

<Space Pointer Function>

The game apparatus 1 according to the present example embodiment obtains an image by the linear image sensor 5 located on each of the side surfaces on the housing 2 taking an image of the side part. This allows the game apparatus 1 to use the peripheral region of the housing 2 as an acceptance region for user operations. The user of the game apparatus 1 places the game apparatus 1, for example, on a flat desk or the like. The user may perform an operation of indicating (pointing) the peripheral region of the housing 2 of the game apparatus 1 with a finger or the like to perform, for example, an operation for a game. In the present example embodiment, this function of the game apparatus 1 is referred to as a space pointer function.

It is not always necessary for the game apparatus 1 to be placed on a desk or the like to implement the space pointer function. For example, it is also possible for the user to hold the game apparatus 1 with one hand and to perform an operation in the peripheral region with the other hand. The space pointer function of the game apparatus 1 may be implemented in any arbitrary location in a space.

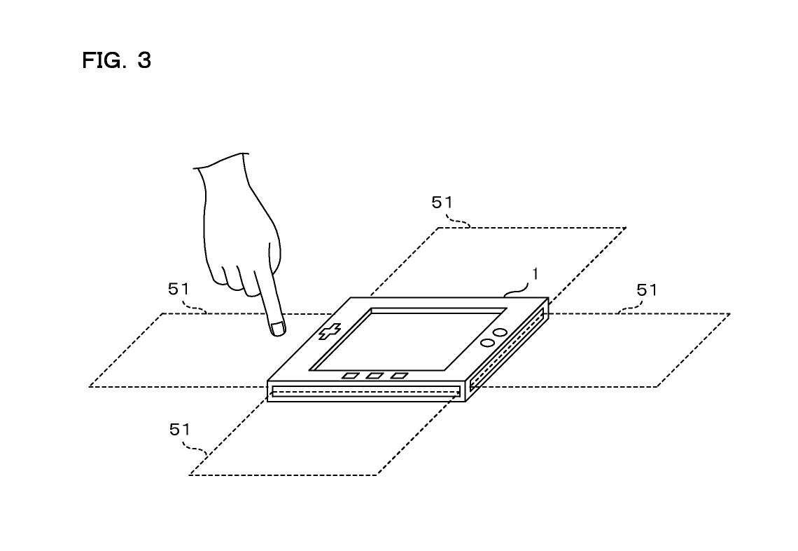

FIG. 3 shows an example non-limiting schematic view for illustrating the space pointer function of the game apparatus 1. When, for example, the game apparatus 1 is placed on a flat desk or the like, the linear image sensor 5 located on a side surface of the housing 2 takes an image in a direction substantially parallel to the desk surface, from the side surface of the housing 2 outward, i.e. in the direction along the desk surface. Thus, the imaging range of the linear image sensor 5 is a substantially rectangular range from the side surface of the housing 2 to a part which is distant from the side surface by a predetermined distance. The regions indicated by broken lines in FIG. 3 are to be operation acceptance regions 51 in the space pointer function. The infrared light source 6 of the game apparatus 1 emits infrared light so that at least the inside areas of the operation acceptance regions 51 are irradiated with the infrared light. Since the game apparatus 1 is provided with linear image sensors 5 respectively on four side surfaces of the housing 2, the operation acceptance regions 51 are located at four sides of the housings 2.

In the game apparatus 1, the linear image sensors 5 receive reflection light of the infrared light emitted from the infrared light source 6 to take an image. A linear image obtained by the linear image sensors 5 taking an image is supplied to the processing unit 10. In the case where no object such as a user's finger is present in the operation acceptance regions 51, the linear image sensors 5 do not receive reflection light, or only receive weak reflection light from an object outside the operation acceptance regions 51. The image obtained by the linear image sensors 5 here is an image with pixels each having a small pixel value. It is to be noted that, in the present example, the image output by the linear image sensors 5 has larger pixel values as the light reception intensity for the infrared light is increased and smaller pixel values as the light reception intensity is decreased. Thus, in the case where the pixel value for the image obtained by the linear image sensor 5 does not exceed a predetermined value, the operation detection unit 21 of the processing unit 10 determines that an object such as a user's finger is not present in the operation acceptance region 51.

On the other hand, in the case where an object such as a user's finger is present in the operation acceptance region 51, the operation detection unit 21 detects the presence of an object in the linear image obtained by the linear image sensor 5, since the pixel value of a pixel corresponding to the position where the object is present exceeds a predetermined value. The reflection light from an object has higher intensity as the distance from a side surface of the housing 2 to the object becomes closer. The operation detection unit 21 can calculate the distance from the housing 2 to an object such as a finger in accordance with the pixel value for the image obtained by the linear image sensor 5. The operation detection unit 21 may obtain the position of an object in the operation acceptance region 51 in accordance with the position of a pixel with the pixel value exceeding a predetermined value in a linear image, and the magnitude of the pixel value of the pixel. It is to be noted that the position of the object may be obtained as coordinates in the vertical and horizontal axes.

The linear image sensor 5 periodically and repeatedly takes images and periodically sends the obtained images to the processing unit 10. The operation detection unit 21 of the processing unit 10 compares multiple images sent from the linear image sensor 5 in time series with each other, to detect the presence/absence of operation, a change in the operating position and the like. For example, in the case where an object is not present in the previous image and an object is present in the current image, the operation detection unit 21 can detect that a new operation is performed by the user. This allows the operation detection unit 21 to detect a pointing operation or the like performed by the user. For example, in the case where the position of an object based on the current image is changed from the position of the object based on the previous image, the operation detection unit 21 can detect that the position of operation by the user is changed. This allows the operation detection unit 21 to detect a sliding operation or the like performed by the user. The sliding operation is, for example, an operation of moving a pointed position. It is to be noted that the operation detection unit 21 may also store the previous detection result, not the previous image, for comparison of detection results.

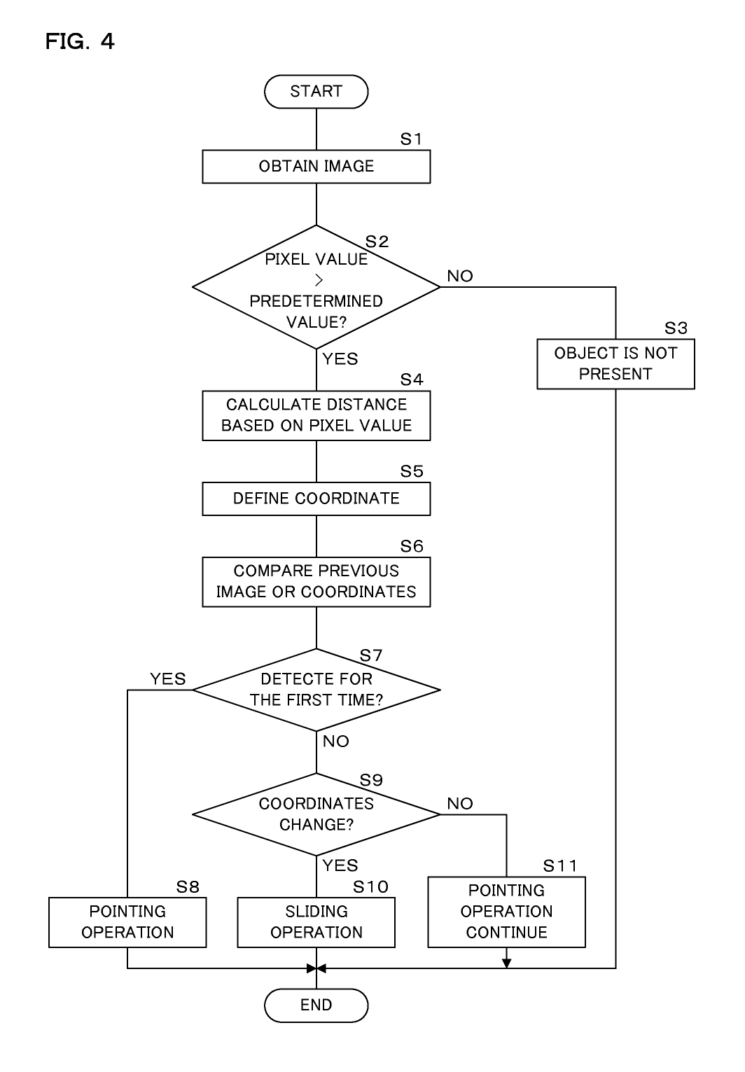

FIG. 4 shows an example non-limiting flowchart illustrating a procedure of processing for a space pointer function performed by a game apparatus 1. The operation detection unit 21 of the processing unit 10 in the game apparatus 1 obtains an image taken by the linear image sensor 5 (step S1). The operation detection unit 21 determines whether or not the pixel value of each pixel in the obtained image exceeds a predetermined value (step S2). If the pixel values of all the pixels do not exceed the predetermined value (S2: NO), the operation detection unit 21 determines that an object is not present in the operation acceptance region 51 (step S3), and terminates the processing. If the pixel value of at least one pixel exceeds the predetermined value (S2: YES), the operation detection unit 21 calculates the distance to an object based on the pixel value exceeding the predetermined value (step S4). The operation detection unit 21 defines the coordinates of an object in the operation acceptance region 51 based on the position of the pixel with the pixel value exceeding the predetermined value and the distance calculated at step S4 (step S5).

The operation detection unit 21 either stores an image obtained by the linear image sensor 5 when the image is obtained at step S1, or stores the coordinates when the coordinates are defined at step S5. The operation detection unit 21 compares the image or coordinates stored in the previous time and the current image or coordinates (step S6). From the comparison result, the operation detection unit 21 determines whether an object detected based on the current image is not detected in the previous image (step S7). In other words, the operation detection unit 21 determines whether or not the object in the current image is detected for the first time. If detection of the object is the first time (S7: YES), the operation detection unit 21 determines that the operation performed by the object is a pointing operation for the coordinates calculated at step S5 (step S8), and terminates the processing.

If detection of the object is not the first time (S7: NO), the operation detection unit 21 compares the coordinates based on the previous image and the coordinates based on the current image, and determines whether or not changes occur in both of the coordinates (step S9). If both of the coordinates are changed (S9: YES), the operation detection unit 21 determines that the current operation is the sliding operation (step S10), and terminates the processing. If no change occurs in both of the coordinates (S9: NO), the operation detection unit 21 determines that the pointing operation continues without a change (step S11), and terminates the processing. The operation detection unit 21 repeatedly performs the processing illustrated in the flowchart of FIG. 4 every time the linear image sensor 5 takes an image.

As described above, the game apparatus 1 detects operations using the linear image sensor 5. Thus, the game apparatus 1 may be provided with, in addition to the touch panel 11 on the display 3, the operation acceptance regions 51 in which the user can perform a pointing operation and the like. In the case where an operation is performed with the touch panel 11, the display 3 is partially hidden by a finger or hand of the user, which degrades the visibility of the display 3 due to the operation. On the other hand, an operation in the operation acceptance regions 51 located at four sides of the housing 2 can be performed without degrading the visibility of the display 3. By the liner image sensors 5 respectively provided at four side surfaces of the housing 2, the operation acceptance regions 51 may be provided at four sides of the housing 2. When, for example, multiple users play a game as opponents or cooperators using one game apparatus 1, such a mode of use can be realized that each of the users performs an operation using one of the operation acceptance regions 51.

While, in the present example embodiment, the game apparatus 1 is configured to calculate the distance to an object in the operation acceptance region 51 based on the intensity of the reflection light of the infrared light received by the linear image sensor 5, the present technology herein is not limited thereto. For example, the game apparatus 1 may also measure a distance by the Time of Flight method. Though not described in detail, with the Time of Flight method, the distance to an object can be measured based on the time during which the infrared light from the infrared light source 6 is reflected by an object and reaches the linear image sensor 5.

### <Additional Interface Function>

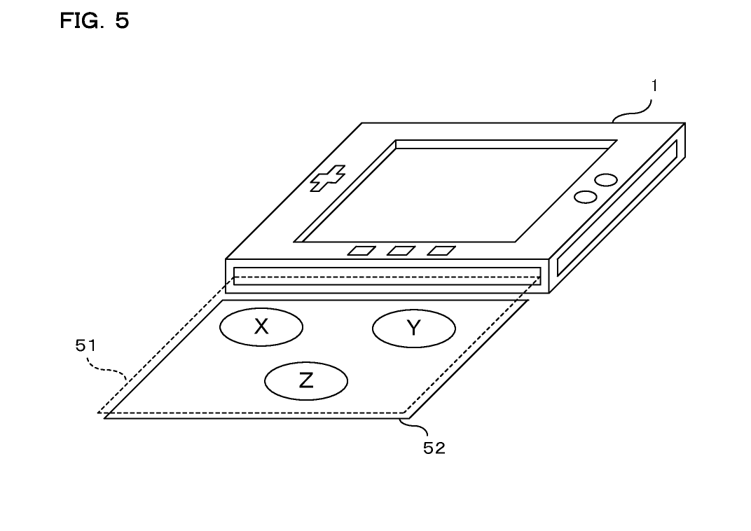

The game apparatus 1 according to the present example embodiment may, using the space pointer function described above, include an operation unit for accepting a pushing operation or sliding operation in the operation acceptance region 51, in addition to the cross key and push buttons at the operation unit 4. FIG. 5 shows an example non-limiting schematic view for illustrating an additional interface function of the game apparatus 1. In the additional interface function of the game apparatus 1 according to the present example embodiment, the user utilizes an additional interface sheet 52 together with the game apparatus 1. The additional interface sheet 52 is, for example, a material such as paper, synthetic resin or wood formed in a sheet-like or plate-like shape, and a picture of an additional interface is printed on the surface thereof. The additional interface sheet 52 may be sold as a package with, for example, the recording medium 9 in which a game program 91 is recorded. The additional interface sheet 52 may be a piece of paper on which, for example, an image file provided in a specific Internet website is printed. The additional interface sheet 52 may also be provided in a way other than the ones described above.

In the case where, for example, the user selects to use the additional interface function on a menu screen, setting screen or the like in a game, the game apparatus 1 displays on the display 3 a message or the like urging the user to prepare the additional interface sheet 52 and place it at a predetermined position. Here, the game apparatus 1 displays on the display 3 instructions on what kind of picture pattern the additional interface sheet 52 is to have thereon and how the additional interface sheet 52 is to be located with respect to the game apparatus 1. In the additional interface sheet 52, a mark or the like for positional alignment with the game apparatus 1 may also be printed.

In the illustrated example, the additional interface sheet 52 is placed at a position on the lower side of the housing 2 with respect to the game apparatus 1 placed on a desk or the like. In the illustrated additional interface sheet 52, three buttons of X, Y and Z are drawn as an additional interface. The additional interface is for accepting a pushing operation or touching operation of the user for each of the buttons X, Y and Z.

The game apparatus 1 stores information such as the coordinates and ranges of the three buttons drawn on the additional interface sheet 52. The operation detection unit 21 of the game apparatus 1 detects the operation of the user for the additional interface sheet 52 in a method similar to that in the case of the space pointer function described above. In the case where a pointing operation for the additional interface sheet 52 is detected, the operation detection unit 21 compares the coordinates at which the pointing operation is performed with the coordinates and ranges of the three buttons drawn on the additional interface sheet 52. If it is determined that the coordinates at which the pointing operation is performed is in the range of any of the three buttons, the operation detection unit 21 accepts the pushing operation for the button. The operation detection unit 21 reflects the accepted operation on the processing for a game or the like in which the additional interface sheet is used.

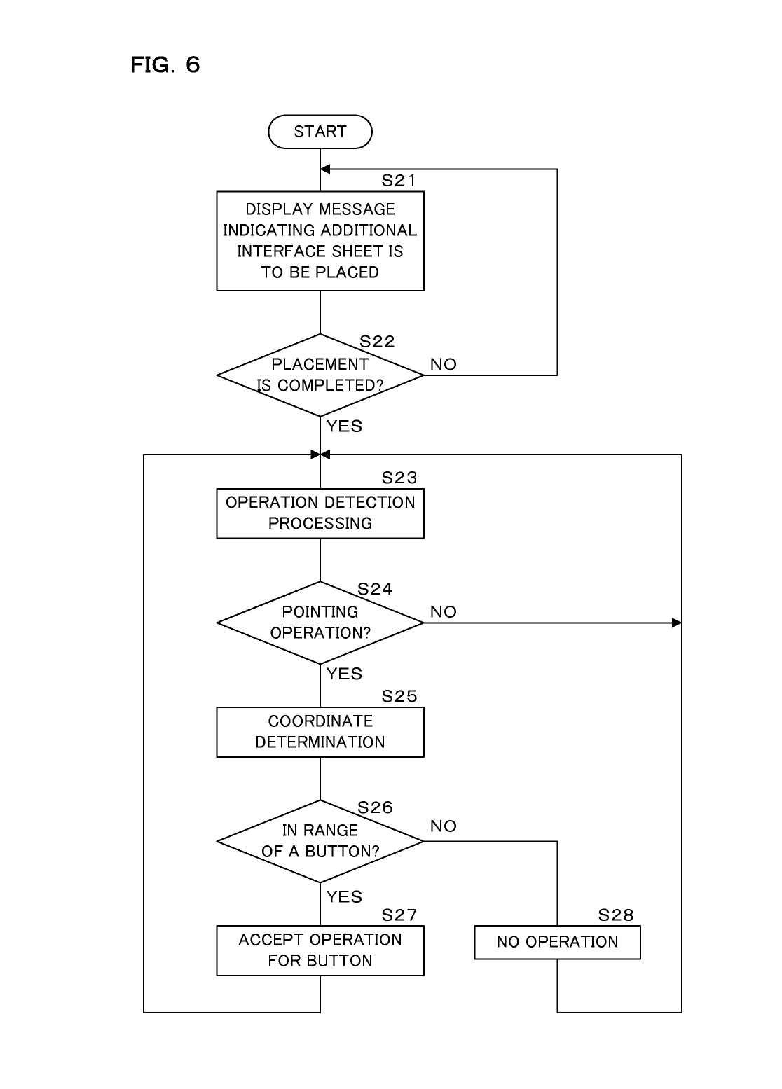

FIG. 6 shows an example non-limiting flowchart illustrating a procedure of processing for the additional interface function performed by the game apparatus 1. The operation detection unit 21 of the processing unit 10 in the game apparatus 1 displays on the display 3 a message indicating that the additional interface sheet 52 is to be placed at a predetermined position with respect to the game apparatus 1 in the case where, for example, the additional interface function is selected for use (step S21). In accordance with the message, the user places the additional interface sheet 52 at a predetermined position. The user may start using the additional interface function by, for example, performing an operation for a complete button or the like displayed together with the message as described above on the display 3. The operation detection unit 21 determines whether or not the placement of the additional interface sheet 52 is completed, based on whether or not an operation for the complete button is performed, for example (step S22). If the placement of the additional interface sheet 52 is not completed (S22: NO), the operation detection unit 21 returns the processing to step S21, and continues displaying a message.

If the placement of the additional interface sheet 52 is completed (S22: YES), the operation detection unit 21 performs the operation detection processing illustrated in the flowchart of FIG. 6 (step S23). The operation detection unit 21 determines whether or not a pointing operation is detected from the result of the operation detection processing (step S24). If no pointing operation is detected (S24: NO), the operation detection unit 21 returns the processing to step S23, and repeatedly performs the operation detection processing. If a pointing operation is detected (S24; YES), the operation detection unit 21 performs coordinate determination which compares the coordinates at which the pointing operation is performed with the coordinates of a button drawn on the additional interface sheet 52 (step S25). Based on the result of coordinate determination, the operation detection unit 21 determines whether or not the pointing operation is performed in the range of a button on the additional interface sheet 52 (step S26). If the pointing operation is in the range of a button (S26: YES), the operation detection unit 21 accepts the pointing operation as an operation for the corresponding button (step S27), and returns the processing to step S23. If the pointing operation is not in the range of a button (S26: NO), the operation detection unit 21 determines that no operation is performed on a button (step S28), and returns the processing to step S23.

As described above, the game apparatus 1 accepts an operation using the additional interface sheet 52. Accordingly, the game apparatus 1 can appropriately add an interface suitable for the operation of a game, which enables enhancement in operability. The additional interface sheet 52 may be realized by, for example, a piece of paper on which a picture pattern is printed, which can easily be realized at low cost.

The additional interface sheet 52 illustrated in FIG. 5 has three buttons drawn thereon, the illustration being by way of a mere example, not by way of any limitation. An operation unit other than buttons, such as a slide bar or a rotating dial for example, may also be drawn on the additional interface sheet 52. The additional interface sheet 52 is not necessarily planar, but may also be stereoscopic. The additional interface sheet 52 may include a mechanical mechanism for moving or shifting positions in accordance with an operation of the user. It is also possible to project a picture pattern of an operation unit on a desk by a projector, instead of the additional interface sheet 52. Though an example where a pointing operation is associated with a button on the additional interface sheet 52, an operation other than the pointing operation may also be used. For example, a sliding operation may be associated with an operation unit drawn on the additional interface sheet 52.

### <Side Surface Touching Operation>

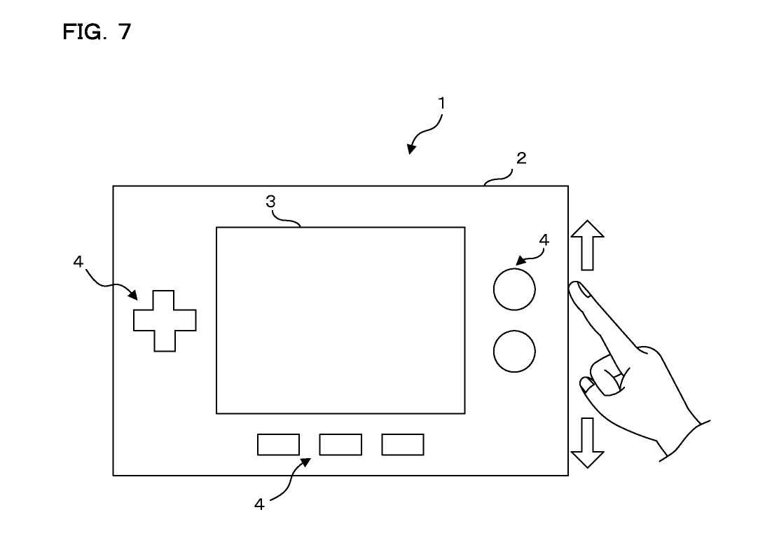

The game apparatus 1 according to the present example embodiment uses the linear image sensor 5 provided on a side surface of the housing 2 to accept an operation of approaching or making contact with a side surface of the housing 2. In the present example embodiment, a side surface touching operation includes a case where a finger or the like of a user actually makes contact with a side surface of the housing 2, and also a case where a finger or the like is placed close to a side surface within a certain distance therefrom without actually being in contact with the side surface. FIG. 7 shows an example non-limiting schematic view for illustrating a side surface touching operation in the game apparatus 1.

The operation detection unit 21 of the game apparatus 1 can detect a touching operation for a side surface of the housing 2 by a method similar to that of the space pointer function described above. In the case where, for example, any operation is detected in a processing procedure of the space pointer function illustrated in FIG. 4, and where the position at which the operation is performed is within a predetermined distance from the housing 2, the operation detection unit 21 can determine that a side surface touching operation is performed.

The type of processing performed by the game apparatus 1 when the operation detection unit 21 detects a side surface touching operation depends on a game program 91 to be executed by the processing unit 10. The side surface touching operation may appropriately be utilized in accordance with the content of the game program 91, as in the touching operation through the touch panel 11. In the illustrated example, a case is shown where the user performs a sliding operation by sliding a finger in the vertical direction along the right side surface of the housing 2. For such a sliding operation at the side surface, the game apparatus 1 can, for example, increase or decrease the volume of music, voice or the like output from a speaker during a game. For example, the game apparatus 1 can increase or decrease the brightness of the display 3.

The side surface touching operation is not limited to the sliding operation as illustrated. For example, the game apparatus 1 may be configured to perform processing such as recovering from a sleep mode or unlocking the game apparatus 1 when a touching operation is performed on a predetermined portion on the side surface of the housing 2. For example, the game apparatus 1 may be configured to decide a moving direction, attacking direction or the like of a game character in accordance with the portion of the side surface of the housing 2 on which the touching operation is performed.

Thus, the game apparatus 1 has a configuration in which a touching operation by the user on the side surface of the housing 2 is detected using the linear image sensor 5. This allows the game apparatus 1 to detect the touching operation on a side surface of the housing 2 without providing a component, which is similar to the touch panel 11 of an electrostatic capacitance type provided on the surface of the display 3, on the side surface of the housing 2.

### <Figure Detection Function>

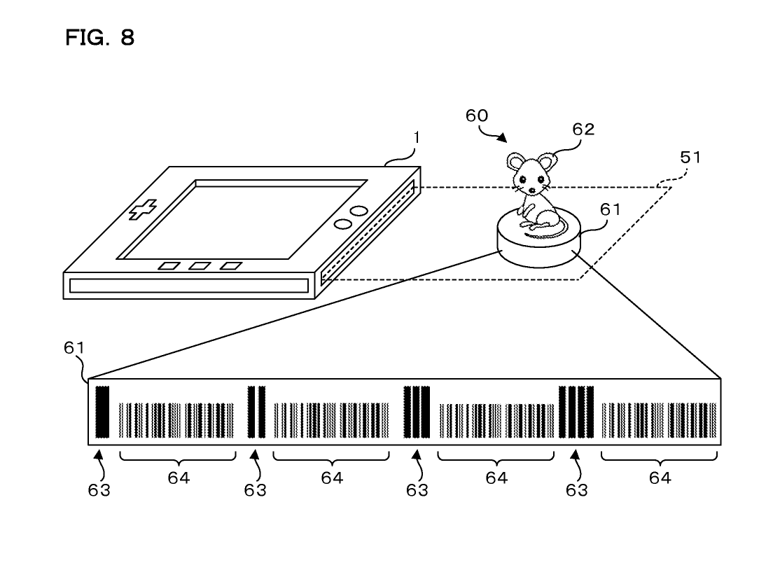

The game apparatus 1 according to the present example embodiment implements a game also using a specific figure associated with a specific game program 91. FIG. 8 shows an example non-limiting schematic view for illustrating a figure detecting function of the game apparatus 1. In the illustrated example, a FIG. 60 representing a character of a mouse is used in a game. The FIG. 60 is, for example, a molded piece made of synthetic resin. The FIG. 60 is provided together with the recording medium 9 in which the game program 91 for implementing a game using the FIG. 60 is recorded, or provided independently from the recording medium 9.

The FIG. 60 includes a base 61 having a substantially cylindrical shape, and a character part 62 located on the base 61. The character part 62 of the FIG. 60 is a stereoscopic representation of a character appearing in a game. Multiple different FIG. 60 representing characters other than the illustrated mouse may also be present. The base 61 of the FIG. 60 is appropriately set to have such a height that allows the linear image sensor 5 of the game apparatus 1 to take an image of the circumferential surface of the base 61 in the case where, for example, the game apparatus 1 and FIG. 60 are placed side by side on a flat desk surface. On the circumferential surface of the base 61, barcode information for identifying a character is printed with infrared reflection coating. This barcode cannot be viewed by the user's eyes, and can be obtained by the linear image sensor 5 receiving reflection light of infrared light from the infrared light source 6 of the game apparatus 1. This barcode is provided along the entire circumferential surface of the base 61, and a part of the image thereof may be taken by the linear image sensor 5 when the FIG. 60 is placed in any orientation.

The figure detection unit 22 of the processing unit 10 in the game apparatus 1 performs processing of detecting the type, position and orientation of a FIG. 60 when the FIG. 60 is placed in the operation acceptance region 51. Since the detection of the position on which the FIG. 60 is placed may be performed by the same method as the method of detecting the position of the pointing operation in the space pointer function described above, the description thereof will not be repeated here.

The figure detection unit 22 detects the type of the FIG. 60 placed in the operation acceptance region 51 based on the barcode indicated on the base 61 of the FIG. 60. As described above, a barcode is indicated on the base 61 of the FIG. 60 across the entire circumference thereof. It is, however, only a part of the barcode that can be obtained by the linear image sensor 5 of the game apparatus 1. Thus, the barcode on the base 61 is so configured that the figure detection unit 22 of the game apparatus 1 is able to determine the type of a character if a third to a fourth of the entire length of the barcode can be obtained. The figure detection unit 22 extracts a portion of the FIG. 60 at which the image of the barcode is taken, from the image obtained by the linear image sensor 5. The figure detection unit 22 converts the extracted barcode into digital data such as an identification number. In the storage unit 12 or recording medium 9 of the game apparatus 1, information on the association between a character and an identification number attached to the FIG. 60 is stored together with the game program 91. The figure detection unit 22 can determine which one of the characters the FIG. 60 corresponds to by referring to the association information based on the identification number obtained from the barcode of the FIG. 60.

The figure detection unit 22 detects the orientation of the FIG. 60 based on the barcode indicated on the base 61 of the FIG. 60. The barcode indicated across the entire circumference of the base 61 is obtained by the linear image sensor 5 of the game apparatus 1 for only a part thereof. Thus, the figure detection unit 22 determines the type, orientation and the like of the FIG. 60 based on the part obtained by the linear image sensor 5.

For example, in the example illustrated in FIG. 8, an orientation detection barcode 63 for detecting the orientation of the FIG. 60 and a type determination barcode 64 for determining a type or the like of the FIG. 60 are alternately arranged at appropriate intervals across the entire circumference of the base 61. The orientation detection barcode 63 and the type determination barcode 64 may, for example, have a difference in thickness of lines constituting the barcodes, which prevents the barcodes from being mixed up.

In the illustrated example, the base 61 is provided with four orientation detection barcodes 63 and four type determination barcodes 64. The barcodes on the base 61 are so configured that the images of at least one orientation detection barcode 63 and one type determination barcode 64 may be taken by the linear image sensor 5 even when the figure is placed in any direction.

Each of the four orientation detection barcodes 63 is a different pattern. The figure detection unit 22 of the game apparatus 1 detects the orientation of the FIG. 60 in accordance with the pattern of the orientation detection barcode 63 obtained by the linear image sensor 5. The figure detection unit 22 is also able to estimate more accurate orientation based on the distortion in the pattern of the obtained orientation detection barcode 63. It is to be noted that the distortion in a pattern corresponds to, for example, a change in the distance between lines constituting the pattern.

The four type determination barcodes 64 all have the same pattern. The figure detection unit 22 can obtain at least one type determination barcode 64 from the image taken by the linear image sensor 5. There may be a case, however, where the type determination barcode 64 is divided into the former half and the latter half while the images thereof are taken with the orientation detection barcode 63 interposed in between. In such a case, the figure detection unit 22 may obtain one type determination barcode 64 by combining the divided former half and latter half.

The information on the type, position, orientation and the like of the FIG. 60 detected by the figure detection unit 22 is reflected in the game processing of the game program 91 using the FIG. 60. For example, the processing unit 10 in the game apparatus 1 makes a character corresponding to the FIG. 60 detected by the figure detection unit 22 appear in a game as a player character operated by the user. The user operates the player character by moving or rotating the FIG. 60 in the operation acceptance region 51. The figure detection unit 22 detects the position and orientation of the FIG. 60, so as to detect the movement and rotation of the FIG. 60. The processing unit 10 can move and rotate the player character displayed on the display 3 in accordance with the movement and rotation of the FIG. 60 detected by the figure detection unit 22.

The figure detecting function of the game apparatus 1 can also be combined with different kinds of board games or the like. For example, the game apparatus 1 is placed at a predetermined position on a game board in a board game, and different kinds of FIG. 60 are used as pieces for the board game. The game apparatus 1 may be configured to recognize the positions of the FIG. 60 on the game board, to allow the game to progress, to make determinations, and the like.

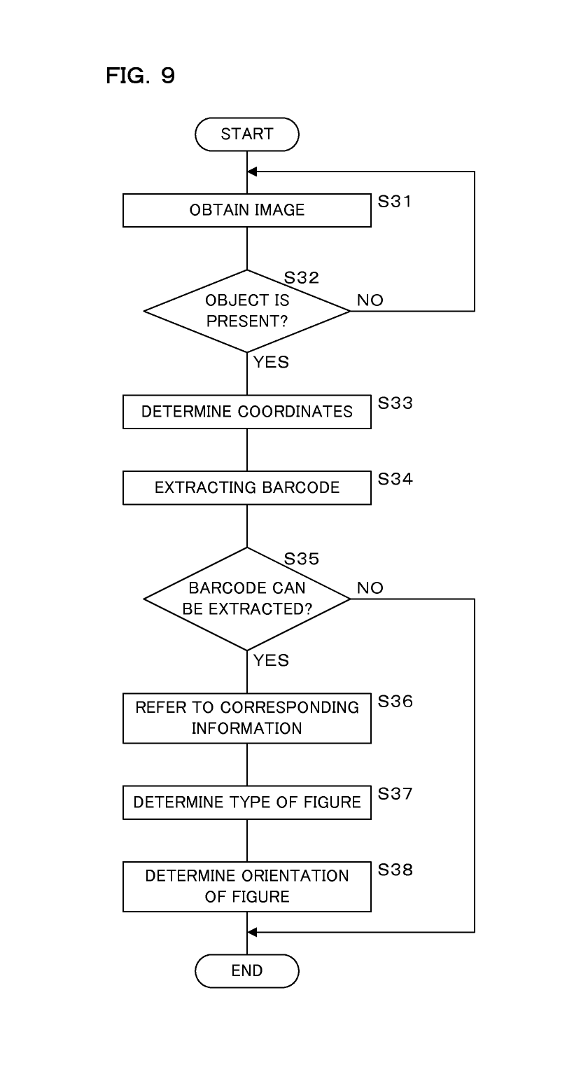

FIG. 9 shows an example non-limiting flowchart illustrating a procedure of processing for a figure detecting function performed by the game apparatus 1. The figure detection unit 22 of the processing unit 10 in the game apparatus 1 obtains an image taken by the linear image sensor 5 (step S31). The figure detection unit 22 determines whether or not any object is present in the operation acceptance region 51 based on the obtained image (step S32). If no object is present in the operation acceptance region 51 (S32: NO), the figure detection unit 22 returns the processing to step S31 and repeatedly obtains images. If an object is present in the operation acceptance region 51 (S32: YES), the figure detection unit 22 determines the coordinates of the object (step S33). For determining coordinates, a method similar to that shown in steps S1 to S5 in the flowchart of FIG. 4 may be adopted, and thus details thereof are not illustrated in FIG. 9.

Subsequently, the figure detection unit 22 performs processing of extracting a barcode from an object determined to be present in the operation acceptance region 51 (step S34). From the result of the processing, the figure detection unit 22 determines whether or not a barcode can be extracted from the object in the operation acceptance region 51 (step S35). If the barcode cannot be extracted (S35: NO), the figure detection unit 22 terminates the processing. If the barcode can be extracted (S35: YES), the figure detection unit 22 determines that the object is a specific FIG. 60. The figure detection unit 22 converts the type determination barcode 64 included in the extracted barcode into digital identification information or the like. The figure detection unit 22 refers to corresponding information stored in the storage unit 12 or recording medium 9 based on the converted identification information (step S36). The figure detection unit 22 determines the type of the FIG. 60 based on the identification information and corresponding information (step S37). The figure detection unit 22 determines the orientation of the FIG. 60 based on the orientation detection barcode 63 included in the obtained barcode (step S38), and terminates the processing. The information such as the position, orientation and type of the FIG. 60 detected by the figure detection unit 22 is used in game processing performed by the processing unit 10.

Accordingly, the game apparatus 1 detects the FIG. 60 arranged at the periphery of the housing 2 using the linear image sensor 5, and reflects the position, orientation, type and the like of the FIG. 60 in the game. This allows the game apparatus 1 to realize a wide variety of games or information processing which cannot be realized by the game apparatus 1 alone. To the FIG. 60, identification information or the like can easily be applied by a barcode or the like. Thus, the FIG. 60 can be provided at low cost compared to the configuration in which, for example, an IC tag or the like is embedded in the FIG. 60 to exchange information with the game apparatus 1.

Though the object arranged at the periphery of the game apparatus 1 is described as the FIG. 60 in the present example embodiment, the technology herein is not limited thereto. For example, a card type medium on which a picture of a character, a barcode and the like are printed may be used as well as other configurations. While the FIG. 60 is configured with the base 61 and the character part 62 stereoscopically representing a character located on the base 61, the technology herein is not limited thereto. For example, it may also be configured that a picture, name or the like of a character is planarly printed on the upper surface of the base 61.

### <Additional Operation Device>

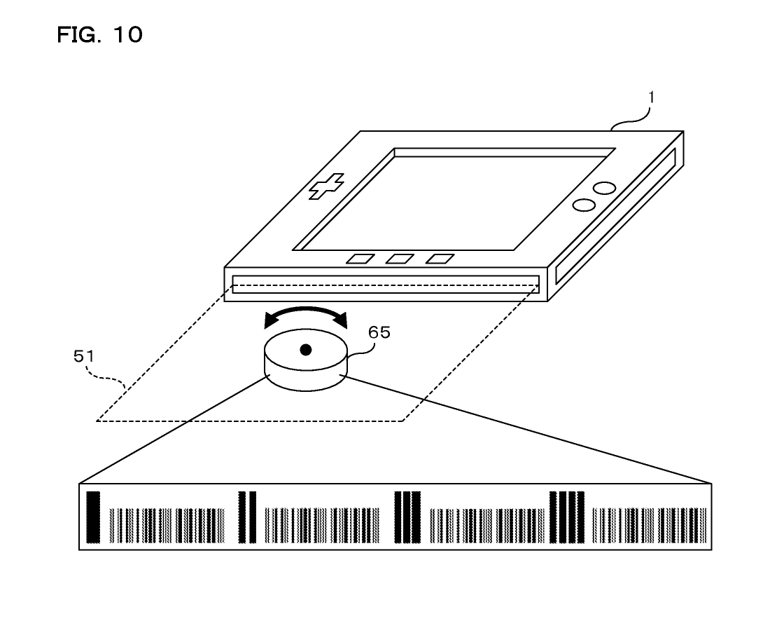

As described above, the game apparatus 1 can accept operation using a button and the like drawn on the additional interface sheet 52 through the additional interface function. The game apparatus 1 according to the present example embodiment can accept an operation by a stereoscopic additional operation device using the linear image sensor 5. FIG. 10 shows an example non-limiting schematic view for illustrating an additional operation device for the game apparatus 1. The game apparatus 1 according to the present example embodiment can use, for example, the illustrated rotating dial 65, as the additional operation device.

The rotating dial 65 is an additional operation device which allows the user to perform a rotating operation in any one of the clockwise and counterclockwise directions. The game apparatus 1 detects a rotating direction, a rotating amount and the like of the rotating dial 65 to reflect them in the game processing. The rotating dial 65 has a substantially columnar shape. The rotating dial 65 is so configured that the relative position of its circumferential surface is changed with respect to the game apparatus 1 in accordance with the rotating operation by the user. For example, the rotating dial 65 may be so configured that its upper and circumferential surfaces rotate with respect to its immobile lower surface. For example, the rotating dial 65 may be an integrally-molded component and may be so configured to rotate as a whole in response to the rotating operation performed by the user. On the circumferential surface of the rotating dial 65, a barcode is printed with an infrared reflection coating material. The barcode of the rotating dial 65 is barcoded identification information indicating the type, orientation and the like of the additional operation device, as in the barcode of the FIG. 60 described above. The barcode may be either visible or invisible for the user.

If any object is present in the operation acceptance region 51 by the linear image sensor 5, the operation detection unit 21 of the game apparatus 1 performs processing of extracting a barcode from the object. If a barcode can be extracted from the object, the operation detection unit 21 converts the extracted barcode into digital identification information or the like. The operation detection unit 21 is able to determine that the object is the rotating dial 65 based on the converted identification information. The operation detection unit 21 can detect an angle or the like of the rotating dial 65 based on the information indicating the orientation included in the barcode obtained by the linear image sensor 5. The processing procedures are substantially the same as those in the figure detecting function as described above, which will thus not be described in detail.

The game apparatus 1 periodically and repeatedly takes images by the linear image sensor 5. The operation detection unit 21 detects a change, displacement or the like of the additional operation device present in the operation acceptance region 51, based on multiple images obtained in time series from the linear image sensor 5. The operation detection unit 21 detects, for example, rotation of the rotating dial 65. If the rotation of the rotating dial 65 is detected, the operation detection unit 21 further detects the amount of displacement, i.e. rotation, for the angle of the rotating dial 65. The processing unit 10 of the game apparatus 1 can perform the game processing or other information processing based on the amount of rotation of the rotating dial 65 detected by the operation detection unit 21.

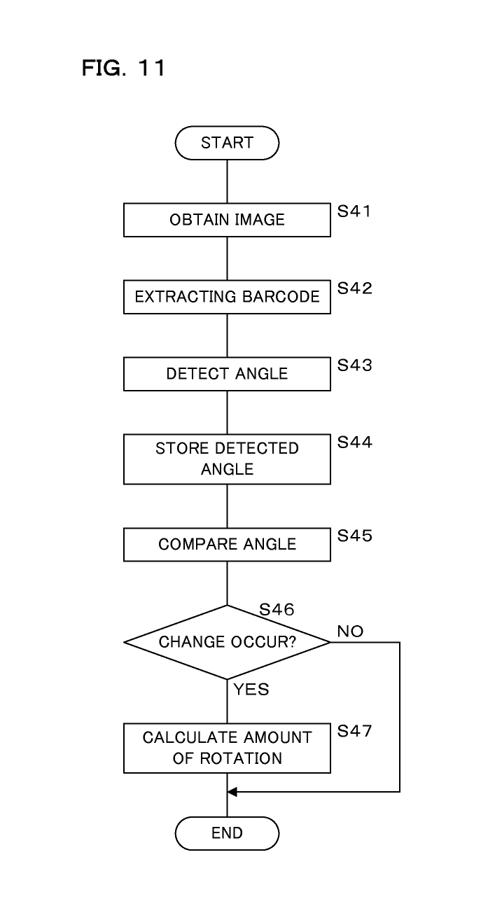

FIG. 11 shows an example non-limiting flowchart illustrating a procedure of processing related to an additional operation device performed by the game apparatus 1. In the present drawing, processing is illustrated which is performed after the game apparatus 1 detects that the additional operation device is placed in the operation acceptance region 51, that the additional operation device is the rotating dial 65, and the angle of the placed rotating dial 65. The operation detection unit 21 of the processing unit 10 in the game apparatus 1 obtains an image taken by the linear image sensor 5 (step S41). The operation detection unit 21 performs processing of extracting a barcode attached to the rotating dial 65 present in the operation acceptance region 51, based on the obtained image (step S42). The operation detection unit 21 detects the angle of the rotation dial 65 based on the extracted barcode (step S43), and stores the detected angle in the storage unit 12 or the like (step S44).

The operation detection unit 21 compares the angle detected and stored based on the previously-obtained image with the angle detected based on the image obtained this time (step S45). The operation detection unit 21 determines whether or not a change occurs in these angles (step S46). If a change occurs (S46, YES), the operation detection unit 21 calculates the amount of rotation of the rotating dial 65 from the difference between the angles (step S47), and terminates the processing. If no change occurs in the angles (S46: NO), the operation detection unit 21 terminates the processing without calculating the amount of rotation. The amount of rotation of the rotating dial 65 detected by the operation detection unit 21 is used in the game processing or the like performed by the processing unit 10.

As described above, the game apparatus 1 detects the additional operation device such as the rotating dial 65 placed in the operation acceptance region 51, using the linear image sensor 5. The game apparatus 1 detects the displacement of the additional operation device by the linear image sensor 5 to reflect the displacement in the game processing. Accordingly, the use of the additional operation device allows the game apparatus 1 to realize the acceptance of a complicated operation, which is difficult to be realized by a planar additional interface sheet 52. The additional operation device can realize such a complicated operation by a simple configuration, e.g., a barcode indicated on a portion to be displaced in accordance with the operation. It is not necessary for an additional operation device to mount thereto an electronic mechanism for detecting an operation, a communication function with the game apparatus 1 and the like. Thus, the additional operation device can be provided at low cost.

Though the description was made by taking the rotating dial 65 as an example for the additional operation device, the additional operation device is not limited thereto. For example, the additional operation device may also be a slide bar which linearly shifts its position in accordance with a sliding operation by the user. For example, the additional operation device may also have such a configuration that a rotating operation by a steering wheel is converted into a linear displacement operation by a rack and pinion mechanism while a barcode or the like is attached to a linearly-displaced portion. Various configurations other than the ones described above may also be employed for the additional operation device.

### <Use Mode Determining Function>

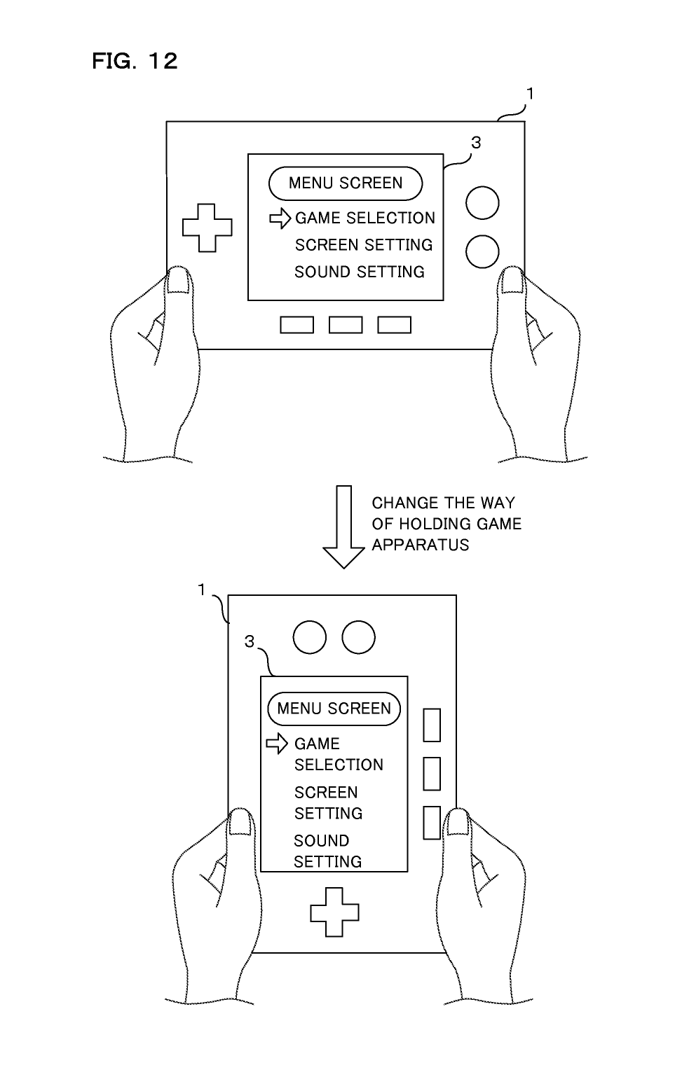

The game apparatus 1 according to the present example embodiment has a function of determining which one of a horizontal posture and a vertical posture the housing 2 has when the user holds the housing 2 during use. In the present example embodiment, this function of the game apparatus 1 is referred to as a use mode determining function. FIG. 12 shows an example non-limiting schematic view for illustrating a use mode determining function of the game apparatus 1. The top part of FIG. 12 illustrates a state where the user is holding the game apparatus 1 to be oriented in the horizontally-long direction. The bottom part of FIG. 12 illustrate a state where the user has changed the way of holding the game apparatus 1 and is now holding it to be oriented in the vertically-long direction. On the display 3 of the game apparatus 1, a menu screen is displayed as an example. On the menu screen in the present example, items for selection such as game selection, screen setting, sound setting and the like are displayed to be vertically aligned with one another. On the menu screen, the user can operate the operation unit 4 to select any of the items.

The game apparatus 1 according to the present example embodiment changes the orientation of an image displayed on the display 3 in accordance with how the game apparatus 1 is used by the user, i.e. whether it is held horizontally or vertically. As illustrated, regardless of whether the game apparatus 1 is used horizontally or vertically, the menu screen on the display 3 is displayed with the side of the display 3 farther from the user being the top and the side closer to the user being the bottom, while items for selection are arranged in the vertical direction.

Whether the game apparatus 1 is used horizontally or vertically is determined by the use mode determination unit 23 of the processing unit 10. The use mode determination unit 23 determines how the game apparatus 1 is used based on the gravitational acceleration sensed by the acceleration sensor 15 and the image obtained by the linear image sensor 5. By determining the direction of the gravitational acceleration sensed by the acceleration sensor 15, the use mode determination unit 23 can determine which direction the housing 2 of the game apparatus 1 is inclined. In place of or in addition to the gravitational acceleration sensed by the acceleration sensor 15, a configuration of determining the direction using the angular velocity sensed by the angular velocity sensor 16 may also be adopted. The determination using the acceleration sensor 15 or angular velocity sensor 16 is an existing technique, which will thus not be described in detail.

The determination on the mode of use by the acceleration sensor 15 may have a lowered determination accuracy when, for example, the game apparatus 1 is used in the state where the housing 2 is maintained in a substantially horizontal direction. The determination on the mode of use may also be degraded in accuracy when the acceleration sensor 15 may possibly sense an acceleration other than the gravitational acceleration, e.g., when the user is using the game apparatus 1 while moving. The game apparatus 1 according to the present example embodiment thus determines a position of the housing 2 where the user is holding, based on the image obtained by the linear image sensor 5. The game apparatus 1 determines how the game apparatus 1 is used based on the held position. While the game apparatus 1 uses both the determination by the acceleration sensor 15 and the determination by the linear image sensor 5, a result of either one of the determinations may be prioritized. The game apparatus 1 may be so configured that the user can set which determination result is prioritized. In the present example embodiment, the game apparatus 1 prioritizes the result of determination by the linear image sensor 5. The game apparatus 1 makes a determination by the acceleration sensor 15 in the case where the mode of use cannot be determined based on the image obtained by the linear image sensor 5.

For example, as illustrated in FIG. 12, it is highly possible for the user to hold the right and left parts of the housing 2 with right and left hands, respectively, when using the game apparatus 1. Since four side surfaces, i.e. upper, lower, right and left surfaces, of the housing 2 are provided with linear image sensors 5, respectively, the linear image sensors 5 are covered at the position held by the user when the user holds the housing 2. In this state, the image taken and obtained by the linear image sensor 5 is an image which can distinguish the part covered with the user's hand and the part not covered therewith. The use mode determination unit 23 of the game apparatus 1 determines that a side surface of the housing 2 is covered when the distance to an object included in the image obtained by the linear image sensor 5 is within a predetermined distance. This is a determination method similar to that in the case of the side surface touching operation as described above.

Furthermore, if approximately one fourth to third of the entire linear image which is obtained by the linear image sensor 5 is covered, the use mode determination unit 23 determines that a side surface of the housing 2 is held by a hand of the user. If it is determined that the two opposed side surfaces out of the four side surfaces of the housing 2 are held by a hand of the user, the use mode determination unit 23 determines that the user holds the housing 2 with both of the right and left hands while using the apparatus. The use mode determination unit 23 determines which end in the longitudinal direction on each of the two side surfaces the position held by the user is closer to. Accordingly, the use mode determination unit 23 determines that the user is holding the housing 2 with the end closer to the held position located at the bottom.

When the user is using the game apparatus 1, the use mode determination unit 23 can determine the vertical orientation of the housing 2, and the processing unit 10 can determine the orientation of the image displayed on the display 3 based on the determination result. It is also possible for the user to hold the housing 2 in a manner other than that illustrated in FIG. 12, such as, for example, by holding the housing 2 with one hand. If the determination cannot be made based on the image obtained by the linear image sensor 5, the use mode determination unit 23 determines the mode of use based on the acceleration sensed by the acceleration sensor 15.

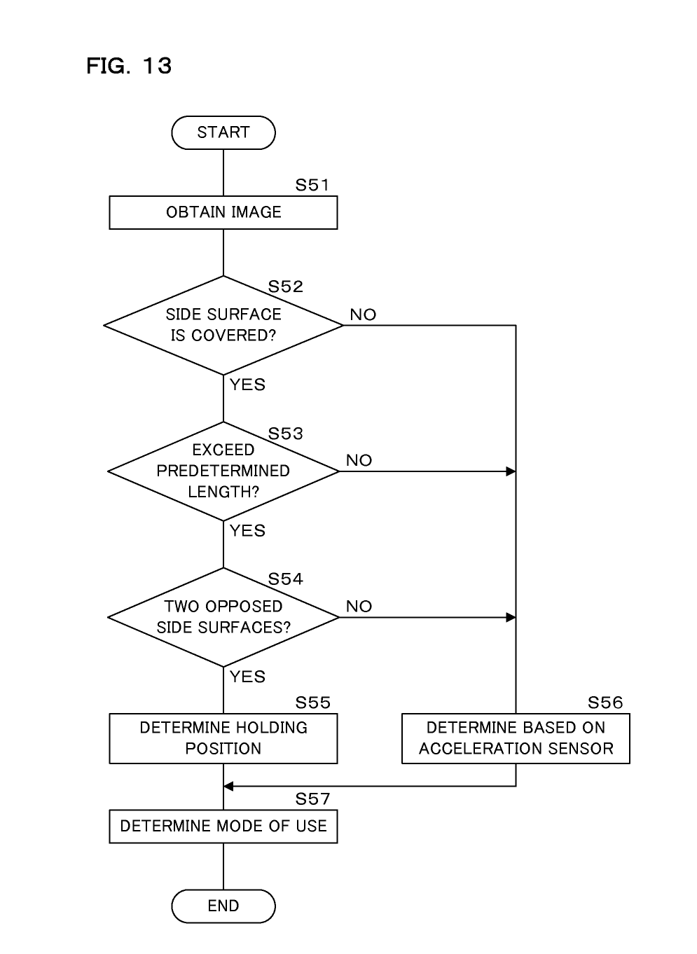

FIG. 13 shows an example non-limiting flowchart illustrating a procedure of use mode determination processing performed by the game apparatus 1. The use mode determination unit 23 of the processing unit 10 in the game apparatus 1 obtains an image taken by the linear image sensor 5 (step S51). The use mode determination unit 23 determines whether or not a side surface of the housing 2 is covered based on the obtained image (step S52). If a side surface of the housing 2 is covered (S52: YES), the use mode determination unit 23 determines whether or not the length of the covered portion exceeds a predetermined length, for example, one fourth to one third of the long side of the side surface (step S53). If the length of the covered portion exceeds the predetermined length (S53: YES), the use mode determination unit 23 determines whether or not two opposed side surfaces of the housing 2 are covered (step S54).

If two opposed side surfaces of the housing 2 are covered (S54: YES), the use mode determination unit 23 performs processing of determining a position of the housing 2 where the user is holding in accordance with which end of each of the side surfaces in the longitudinal direction the covered portion is closer to (step S55). The use mode determination unit 23 determines the mode of use of the game apparatus 1, i.e. whether the game apparatus 1 is used horizontally or vertically, based on the determined held position (step S57), and terminates the processing.

If it is determined that a side surface of the housing 2 is not covered based on the image obtained by the linear image sensor 5 (S52: NO), that a covered portion on a side surface of the housing 2 has a length not exceeding a predetermined value (S53: NO), or that two opposed side surfaces of the housing 2 are not covered (S54: NO), the use mode determination unit 23 determines the vertical orientation based on the gravitational acceleration sensed by the acceleration sensor 15 (step S56). Based on the result of determination by the acceleration sensor 15, the use mode determination unit 23 determines the mode of use for the game apparatus 1 (step S57), and terminates the processing.

As described above, the game apparatus 1 determines which side surface the user is holding based on the image obtained by the linear image sensor 5 located on each of the four side surfaces of the housing 2, to determine the mode of use for the game apparatus 1. In accordance with the determined mode of use, the game apparatus 1 performs processing of changing the orientation of the image displayed on the display 3. Thus, even in a situation where the acceleration sensor 15 cannot accurately determine the mode of use for the game apparatus 1, the game apparatus 1 can determine the mode of use based on the image obtained by the linear image sensor 5. By the determination additionally using the acceleration sensor 15, the game apparatus 1 can more accurately determine the mode of use.

In the present example, the game apparatus 1 determines the mode of use thereof by determining four conditions, i.e., whether a side surface of the housing 2 is covered, the length of the covered portion, whether two opposed side surfaces of the housing 2 are covered, and which end of each side surface the covered portion is closer to. These conditions are, however, mere examples. Another condition may further be added to the four conditions. Only three or less conditions out of the four conditions may be used in the determination. Some of the four conditions may be combined with another condition in the determination. An example where a menu screen is displayed on the display 3 in the present example, which is a mere example, and any image may be displayed on the display 3.

Though the present example described the processing of changing the orientation of the screen displayed on the display 3 by the game apparatus 1 in accordance with the mode of use determined based on which side surface the user is holding, the processing performed by the game apparatus 1 is not limited thereto. The game apparatus 1 may perform various kinds of processing other than above in accordance with the result of determination on the mode of use. In addition to the processing of changing the orientation of display in accordance with the determination result, the processing in consideration of the position of a side surface where the user is holding may also be performed. For example, the game apparatus 1 can perform processing such as displaying an icon, a game character or the like displayed on the display 3 near the position held by the user.

### <Pulse Detecting Function>

The game apparatus 1 according to the present example embodiment includes a function of detecting a pulse of the user based on an image obtained by the linear image sensor 5 while the user is holding the housing 2. The game apparatus 1 emits infrared light to the outside of the housing 2 by the infrared light source 6, the infrared light being reflected by a hand of the user who is holding the housing 2 and received by the linear image sensor 5. The intensity of the reflection light of the infrared light received by the linear image sensor 5 changes in accordance with the blood flow in the blood vessels of the user. The reflection intensity of the reflection light is transferred as a pixel value in the image obtained by the linear image sensor 5.

The pulse detection unit 24 of the processing unit 10 in the game apparatus 1 periodically or continuously obtains images by the linear image sensor 5. The pulse detection unit 24 obtains the pixel values from a plurality of images obtained for a predetermined period of time, to determine a change in the reflection intensity of the infrared light. The reflection intensity of the infrared light is repeatedly increased and decreased in accordance with a change in the blood flow, i.e. the pulse, of the user. Accordingly, the pulse detection unit 24 can detect the pulse of the user by calculating the cycle of changes from the pixel values obtained from multiple images.

The pulse detected by the pulse detection unit 24 can be utilized in, for example, an application for managing the user's health. The game apparatus 1 can reflect the detected pulse in the game processing by, for example, changing the facial expression of a character in a game in accordance with the pulse detected by the pulse detection unit 24.

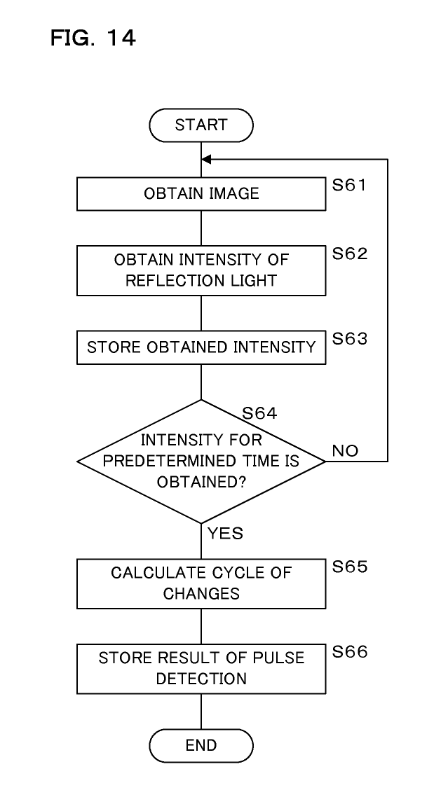

FIG. 14 shows an example non-limiting flowchart illustrating a procedure of pulse detection processing performed by the game apparatus 1. It is to be noted that the present example flowchart is illustrated on the assumption that the user is holding the housing 2 of the game apparatus 1, and thus the processing of determining whether the user is holding the housing 2 or not will not be described here. The game apparatus 1 may perform the processing of determining whether or not the user is holding the housing 2 prior to the processing illustrated in the present example flowchart. The determination processing may employ a method similar to that in the determination processing for a mode of use as described above.

The pulse detection unit 24 of the processing unit 10 in the game apparatus 1 obtains an image taken by the linear image sensor 5 (step S61). The pulse detection unit 24 obtains the intensity of the reflection light of the infrared light by a user's hand, based on the pixel value of the obtained image (step S62). The pulse detection unit 24 stores the obtained intensity in the storage unit 12 or the like (step S63). The pulse detection unit 24 determines whether or not the intensity for a predetermined time corresponding to, for example, several seconds to several tens of seconds is obtained (step S64). If the intensity for a predetermined time is not obtained (S64: NO), the pulse detection unit 24 returns the processing to step S61 to repeatedly obtain the intensity of the reflection light of the infrared light based on the image obtained by the linear image sensor 5.

If the intensity of the reflection light for a predetermined time is obtained (S64: YES), the pulse detection unit 24 reads out multiple intensities stored in the storage unit 12. The pulse detection unit 24 calculates the cycle of changes in the intensities in time series by, for example, detecting a peak value (step S65). The pulse detection unit 24 stores the calculated cycle in the storage unit 12 as a result of pulse detection (step S66), and terminates the processing.

As described above, the game apparatus 1 receives, by the linear image sensor 5, reflection light of the infrared light emitted from the infrared light source 6, the reflection being caused by a user's hand or the like, and detects the pulse of the user based on a change in the intensity of the reflection light. Since the user often holds the housing 2 of the game apparatus 1 when playing a game, the game apparatus 1 can easily detect the pulse based on the image obtained by the linear image sensor 5 located on each side surface of the housing 2. It is easy for the game apparatus 1 to reflect the detected pulse in game processing or the like. It is to be noted that the detected pulse of the user may be used for, not limited to the health management of the user or a change in the facial expression of a game character, but also for other various kinds of processing.

### <Other Device Detecting Function>

The game apparatus 1 according to the present example embodiment includes a function of detecting the position of a different game apparatus 1 having a similar configuration. The game apparatus 1 detects the position of a different game apparatus 1 based on an image obtained by receiving infrared light emitted from the infrared light source 6 of the different game apparatus 1 by the linear image sensor 5. As the housing 2 of the game apparatus 1 is provided with linear image sensors 5 at four side surfaces thereof, respectively, the game apparatus 1 can detect the position of the different game apparatus 1 in accordance with which one of the linear image sensor located on the respective side surfaces received the infrared light emitted from the different game apparatus 1. The game apparatus 1 can detect the orientation of a different game apparatus 1 based on the intensity of the infrared light received by the linear image sensor 5. In order to detect the position as described above, the game apparatus 1 wirelessly communicates with the different game apparatus 1 and adjusts timing for the infrared light source 6 to emit light.

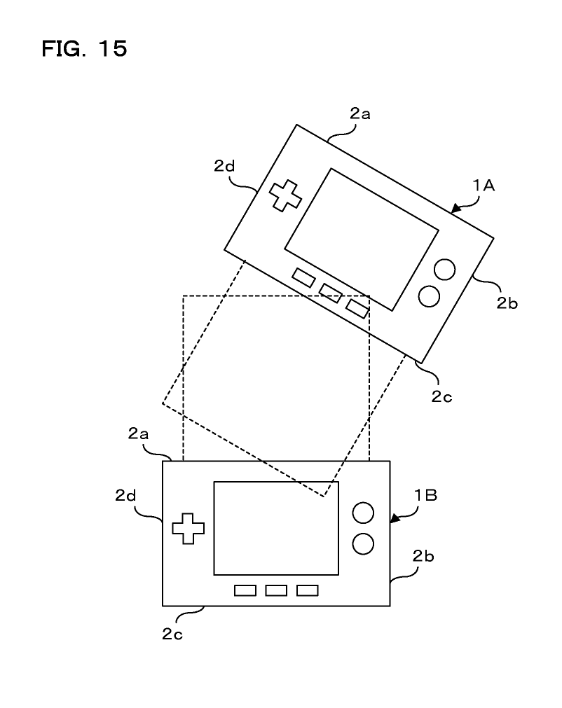

FIG. 15 shows an example non-limiting schematic view for illustrating a function of the game apparatus 1 for detecting a different apparatus. FIG. 15 illustrates a state where two game apparatuses 1 are placed on a flat surface such as on a desk, for example. It is to be noted that the function of detecting a different apparatus according to the present example embodiment is described on the assumption that multiple game apparatuses 1 for which the positions thereof are to be detected are placed on the same plane. While two game apparatuses 1 are illustrated in FIG. 15, the apparatus 1 on the top is referred to as a game apparatus 1A and that on the bottom is referred to as a game apparatus 1B. As for the four side surfaces of the housing 2 of the game apparatus 1, the side not provided with the operation unit 4 is referred to as a side surface 2a, the side provided with two circular push buttons is referred to as a side surface 2b, the side provided with three quadrangular push buttons is referred to as a side surface 2c, and the side provided with a cross key is referred to as a side surface 2d.

In the case where the two game apparatuses 1A and 1B perform processing of detecting positions, first, wireless communication is performed between the game apparatuses 1A and 1B, to decide the order and timing for emitting infrared light by the infrared light source 6. If it is decided here that the game apparatus 1A first emits light from the infrared light source 6 and that the light is emitted at time t0, the game apparatus 1A makes the infrared light source 6 located on the side surface 2a at the time to for a predetermined period of time. Then, the game apparatus 1A sequentially makes the infrared light sources 6 on the side surfaces 2b, 2c and 2d independently for a predetermined period of time. The game apparatus 1B not emitting light from the infrared light source 6 receives and takes an image of the infrared light from the game apparatus 1A using all the linear image sensors 5.

In the example illustrated in FIG. 15, when the game apparatus 1A emits light from the infrared light source 6 on the side surface 2c, the infrared light is received by the linear image sensor 5 located on the side surface 2a of the game apparatus 1B. Thus, the game apparatus 1B can determine that the game apparatus 1A is placed on the side surface 2a side. The game apparatus 1B can calculate the distance from the side surface 2a to the game apparatus 1A in accordance with the reception intensity of infrared light from the game apparatus 1A, i.e. the pixel value of the image obtained by the linear image sensor 5 on the side surface 2a. The game apparatus 1B can determine the inclination of the game apparatus 1A with respect to the game apparatus 1B by checking the distribution of pixel values of the linear image obtained by the linear image sensor 5 on the side surface 2a. In other words, it can be determined that the distance from the linear image sensor 5 to the game apparatus 1A is closer at a portion where the intensity of the received infrared light is higher. Accordingly, the game apparatus 1B can determine that the game apparatus 1A is inclined toward the portion with higher intensity of infrared light.

After the game apparatus 1A finishes emitting light from the infrared light source 6, the game apparatus 1B emits light from the infrared light source 6. As in the case with the game apparatus 1A, the game apparatus 1B makes the respective infrared light sources 6 emit light in the order of the side surfaces 2a, 2b, 2c and 2d starting from the time t1 and each emitting for a predetermined period of time. When the game apparatus 1B makes the infrared light source on the side surface 2a emit light, the game apparatus 1A receives infrared light by the linear image sensor 5 on the side surface 2c. The game apparatus 1A determines the position, distance, orientation and the like for the game apparatus 1B based on the image obtained by the linear image sensor 5.

By both the game apparatuses 1A and 1B finish emitting light from the infrared light source 6 and receiving light by the linear image sensor 5, and finish determining the position, distance, orientation and the like of the other apparatus, the processing of detecting positions of the game apparatuses 1A and 1B is terminated. Each of the game apparatuses 1A and 1B may also transmit the result of its own determination to the other apparatus through wireless communication. Each of the game apparatuses 1A and 1B can compare the result of its own positional detection processing and the result of the other apparatus, to confirm if there is an error in the processing results.

Though the case where the positional detection is performed by two game apparatuses 1 has been described in the example above, the processing may also be performed in a similar procedure in the case where three or more game apparatuses 1 perform positional detection. For example, three game apparatuses 1 wirelessly communicate with one another to decide the order and timing of making the infrared light sources 6 emit light, and each game apparatus 1 makes the infrared light source 6 emit light in accordance with the decided order and timing of light emission. The remaining two game apparatuses 1 not making the infrared light sources 6 emit light receive light by the linear image sensors 5, to determine the position, distance, orientation and the like of the game apparatus 1 making the infrared light source 6 emit light. Here, the results of detection by the linear image sensors 5 may be exchanged through wireless communication between the two game apparatuses 1 not making the infrared light sources 6 emit light. By sharing the detection results among multiple game apparatuses 1, the position, distance, orientation and the like of the game apparatus 1 making the infrared light source 6 emit light can more accurately be determined.

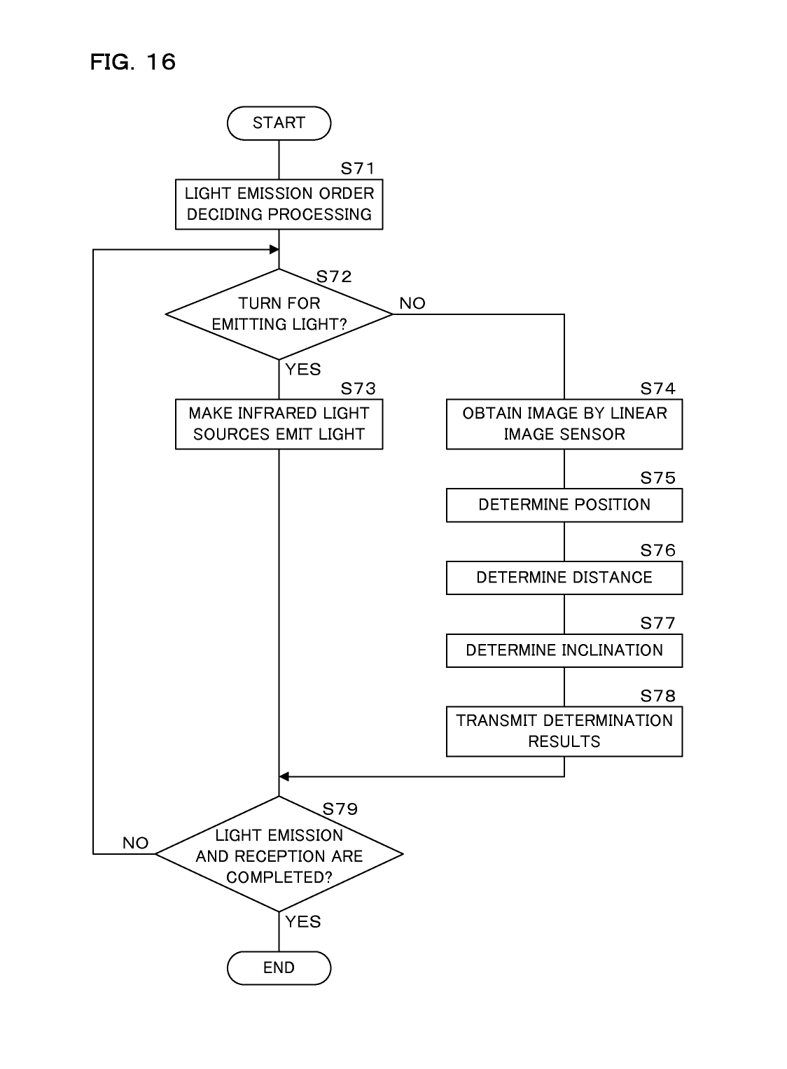

FIG. 16 shows an example non-limiting flowchart illustrating a procedure of processing for detecting a different apparatus performed by the game apparatus 1. The different apparatus detection unit 25 of the processing unit 10 in the game apparatus 1 communicates with a different game apparatus 1 at the wireless communication unit 14, to perform light emission order deciding processing of deciding the order, timing and the like for emitting light from the infrared light source 6 (step S71). After the light emission order deciding processing is finished, the different apparatus detection unit 25 determines whether or not it is the turn of the apparatus itself for emitting light from the infrared light source 6 (step S72). If it is the turn of the apparatus itself for emitting light (S72: YES), the different apparatus detection unit 25 makes four infrared light sources 6 by turns at the light emitting timing decided at step S71, each for a predetermined period of time (step S73), and proceeds to step S79.

If it is not the turn of the apparatus itself for emitting light from the infrared light source 6 (S72: NO), the different apparatus detection unit 25 takes and obtains an image by the linear image sensor 5 (step S74). Based on the obtained image, the different apparatus detection unit 25 determines which linear image sensor 5 receives infrared light from a different game apparatus 1, to determine the position of the different game apparatus 1 (step S75). The different apparatus detection unit 25 determines the distance to the different game apparatus 1 based on the pixel values of the obtained image (step S76). The different apparatus detection unit 25 determines the inclination of the different game apparatus 1 based on the distribution of the pixel values in the obtained image (step S77). The different game apparatus detection unit 25 transmits the determination results at steps S75 to S77 to the different game apparatus 1 through the wireless communication unit 14 (step S78), and proceeds to step S79.

After the processing of steps S73 or S78, the different apparatus detection unit 25 determines whether or not light emission from the infrared light source 6 of the apparatus itself and reception of the infrared light from the different game apparatus 1 by the linear image sensor 5 are both completed (step S79). If both the light emission and light reception are not completed (S79: NO), the different apparatus detection unit 25 returns the processing to step S72. If both the light emission and light reception are completed (S79: YES), the different apparatus detection unit 25 terminates the processing.

The game apparatus 1 utilizes the infrared light source 6 and linear image sensor 5 to cooperate with a different game apparatus 1 to detect the position of the different game apparatus 1 and also to allow the different game apparatus 1 to detect the position of the game apparatus 1 itself. Accordingly, it is possible to easily implement a function of, for example, displaying one image on multiple game apparatuses 1 by displaying different parts of a common image respectively on the displays 3 of the game apparatuses 1, which is a so-called multi-display function. For example, in the case where multiple users utilize game apparatuses 1 respectively and play a game for competing or cooperating through wireless communication or the like, the position of each game apparatus 1 can be reflected in the game. It is, for example, possible to perform processing of associating the position of a character operated by each game apparatus 1 with the actual position of the game apparatus 1. It is to be noted that the result of the detection for the position of the different game apparatus 1 by the game apparatus 1 may also be utilized in various kinds of information processing, not limited to the processing described above.

While the positional detection is performed in the state where multiple game apparatuses 1 are placed on a desk or the like in the present example embodiment, it is not limited thereto. It is also possible to detect positions of multiple game apparatuses 1 not placed on one same plane by appropriately setting, for example, the light emission range of the infrared light from the infrared light source 6 and the light reception range of the linear image sensor 5.

### CONCLUSION

The game apparatus 1 according to the present example embodiment can implement the functions as described below by providing a linear image sensors 5 on a side surface of the housing 2.
space pointer function
additional interface function
side surface touching function
figure detecting function
additional operation device
use mode determining function
pulse detecting function
different apparatus detecting function

Having these functions, the game apparatus 1 according to the present example embodiment can attain an operability not provided in the conventional game apparatus. Though the game apparatus 1 is configured to include all of the functions described above in the present example embodiment, it is not limited thereto. The game apparatus 1 may also be configured to include some of the functions described above. Though all of the four side surfaces of the housing 2 are provided with linear image sensors 5 respectively, the present technology herein is not limited thereto. The number of linear image sensors 5 mounted may appropriately be increased or decreased in accordance with the function to be implemented. For example, in the case where the housing of the game apparatus 1 is formed with the first housing and the second housing capable of being folded by a hinge mechanism or the like, such as in the case of a notebook personal computer, the linear image sensor 5 may be located at any one of or both of the first and second housings. In the case where the game apparatus is a stationary type, the linear image sensor 5 may be located at a controller connected with or without wire, not at the main body of the game apparatus. For example, the linear image sensor 5 may be provided facing outward at a corner part of the housing 2 of the game apparatus 1. For example, one linear image sensor 5 may be provided across multiple side surfaces of the housing 2.

While the game apparatus 1 is configured to realize the functions described above using the linear image sensor 5, the present technology herein is not limited thereto. It may also be configured to have, for example, multiple light receiving elements such as photodiodes arranged linearly on a side surface of the housing 2 in place of the linear image sensor 5. For example, a camera or an image sensor capable of capturing an image at a wide angle perspective may be provided on a side surface of the housing 2. Though the linear image sensor 5 has been described to receive infrared light, it is not limited thereto. In the case of not using the pulse detecting function, the linear image sensor 5 may have a configuration of receiving visible light or the like, not limited to infrared light.

While the game apparatus 1 has been described as an example in the present example embodiment, the present technology herein is not limited thereto. It is also possible to apply a similar technique to various information processing devices such as, for example, a general-purpose computer, tablet terminal device, smartphone and mobile phone. Though it is configured that the operation detection unit 21 to different apparatus detection unit 25 are provided as software functional blocks as the processing unit 10 of the game apparatus 1 executes the game program 91, the present technology herein is not limited to this configuration. A part of the functions of the operation detection unit 21 to the different apparatus detection unit 25 may be provided as, for example, a function of OS (Operating System). A part of the functions of the operation detection unit 21 to the different apparatus detection unit 25 may be provided as a hardware functional block.

It is to be understood that elements and the like in singular form preceded by an article “a” or “an” do not exclude more than one elements related thereto when used in the present specification.

The present technique is configured to provide a linear image sensor, an image sensor, an optical sensor or the like on a side surface of a housing, which is used for sensing outside the housing, to perform information processing based on the result of sensing. This allows a region outside the housing of an information processing apparatus to be used for an operation, thereby realizing a various kinds of operation acceptance processing.

What is claimed is:

1. An information processing apparatus, comprising:
a housing having at least one surface provided with a display;
a linear image sensor located, facing outside the housing, at a side part or a corner part of the housing viewed from a front side corresponding to the surface provided with the display; and
an information processing unit performing information processing based on an image obtained by the linear image sensor.

2. The information processing apparatus according to claim 1, wherein the linear image sensor is oriented in a direction along the surface provided with the display.

3. The information processing apparatus according to claim 1, wherein the linear image sensor is located at each of at least two side parts of the housing.

4. The information processing apparatus according to claim 1, wherein
the housing has a shape of a plate, and
the linear image sensor is located at each of four side parts of the surface provided with the display.

5. The information processing apparatus according to claim 1, wherein the linear image sensor obtains an image by deep focus imaging.

6. The information processing apparatus according to claim 1, further comprising a detection unit detecting a position of an object present outside the housing, based on an image obtained by the linear image sensor,
wherein the information processing unit performs information processing in accordance with the position detected by the detection unit.

7. The information processing apparatus according to claim 1, further comprising a detection unit detecting an operation performed by a user outside the housing, based on an image obtained by the linear image sensor,
wherein the information processing unit performs information processing in accordance with the operation detected by the detection unit.

8. The information processing apparatus according to claim 7, wherein the detection unit detects an operation for the operation indicator located outside the housing.

9. The information processing apparatus according to claim 1, further comprising an identification information obtaining unit obtaining identification information indicated on an object present outside the housing, based on an image obtained by the linear image sensor,
wherein the information processing unit performs information processing based on the identification information obtained by the identification information obtaining unit.

10. The information processing apparatus according to claim 9, further comprising a determination unit determining an orientation of the object based on the identification information obtained by the identification information obtaining unit,
wherein the information processing unit performs information processing based on the orientation determined by the determination unit.

11. The information processing apparatus according to claim 9, further comprising a displacement detection unit detecting a displacement of the object, based on a plurality of pieces of identification information obtained by the identification information obtaining unit in time series on a basis of a plurality of images obtained by the linear image sensor in time series,
wherein the information processing unit performs information processing based on the displacement detected by the displacement detection unit.

12. The information processing apparatus according to claim 9, wherein
the object has a shape representing a character concerning a game or a part on which the character is drawn, and
the information processing apparatus performs game processing concerning a character corresponding to the identification information obtained by the identification information obtaining unit.

13. The information processing apparatus according to claim 1, wherein
the housing is a handheld type,
the information processing apparatus further comprises a position determination unit determining a holding position of the housing, based on an image obtained by the linear image sensor, and
the information processing unit performs information processing based on the holding position determined by the position determination unit.

14. The information processing apparatus according to claim 1, wherein
the housing is a handheld type,
the information processing apparatus further comprises a posture determination unit determining a posture of the housing when a user holds the housing, based on the image obtained by the linear image sensor, and
the information processing unit performs information processing based on the posture determined by the posture determination unit.

15. The information processing apparatus according to claim 14, further comprising an acceleration sensor located in the housing,
wherein the posture determination unit makes a determination based on an image obtained by the linear image sensor and an acceleration sensed by the acceleration sensor.

16. The information processing apparatus according to claim 13, wherein the information processing unit performs processing of switching an orientation of an image displayed on the display in accordance with a result of determination by the position determination unit.

17. The information processing apparatus according to claim 14, wherein the information processing unit performs processing of switching an orientation of an image displayed on the display in accordance with a result of determination by the posture determination unit.

18. The information processing apparatus according to claim 1, further comprising an approach detection unit detecting an operation of approaching or making contact with the linear image sensor based on an image obtained by the linear image sensor,
wherein the information processing unit performs information processing in accordance with the operation detected by the approach detection unit.

19. The information processing apparatus according to claim 1, further comprising a light emission unit emitting infrared light toward an outside of the housing,
wherein the linear image sensor obtains an image according to infrared light emitted by the light emission unit or reflection light of the infrared light.

20. The information processing apparatus according to claim 19, further comprising a pulse detection unit detecting a pulse of a user based on an image according to the reflection light obtained by the linear image sensor,
wherein the information processing unit performs information processing based on the pulse detected by the pulse detection unit.

21. The information processing apparatus according to claim 20, wherein the information processing unit performs information processing concerning a game based on the pulse detected by the pulse detection unit.

22. The information processing apparatus according to claim 19, further comprising an apparatus detection unit detecting a position of a different information processing apparatus, based on an image obtained by the linear image sensor in accordance with infrared light emitted from a light emission unit of the different information processing apparatus,
wherein the information processing unit performs information processing based on the position detected by the apparatus detection unit.

23. The information processing apparatus according to claim 22, further comprising:
a communication unit wirelessly communicating with the different information processing apparatus; and
a light emission control unit communicating with the different information processing apparatus through the communication unit and controlling timing at which the light emission unit emits infrared light,
wherein the apparatus detection unit performs detection based on an image obtained by the linear image sensor in accordance with the timing at which the different information processing apparatus emits infrared light.

24. The information processing apparatus according to claim 1, further comprising a contact operation sensing unit sensing a contact operation with respect to the display,
wherein the information processing unit performs information processing based on at least one of an image obtained by the linear image sensor and a contact operation sensed by the contact operation sensing unit.

25. An information processing apparatus, comprising:
a housing having at least one surface provided with a display and having a shape which can be held by a user;
a detection unit located at a side part of the housing and detecting an operation of approaching or making contact with the side part; and
an information processing unit performing information processing in accordance with an operation detected by the detection unit.

26. The information processing apparatus according to claim 25, wherein the detection unit detects an operation of approaching or making contact with the side part in a case where a user holds the housing.

27. The information processing apparatus according to claim 25, comprising an image sensor located on the side part,
wherein the detection unit detects an operation based on an image obtained by the image sensor.

28. An information processing apparatus, comprising:
a housing having at least one surface provided with a display;
a light emission unit emitting light toward an outside of the housing;
a light reception unit located at a side part of the housing;
a detection unit detecting a position of a different information processing apparatus by receiving, at the light reception unit, light emitted by a light emission unit of the different information processing apparatus; and
an information processing unit performing information processing based on a position detected by the detection unit.

29. A handheld information processing apparatus, comprising:
a housing having at least one surface provided with a display;
an image sensor located, facing outside the housing, at a side part of the housing viewed from a front side corresponding to the surface provided with the display;
a projector for projecting an interface image on a predetermined surface outside the housing; and
a detection unit detecting an operation by a user for at least part of the interface image projected by the projector, based on an image obtained by the image sensor,
an information processing unit performing information processing based on the operation detected by the detection unit.

30. An information processing system, comprising:
a housing having at least one surface provided with a display;
a linear image sensor located, facing outside the housing, at a side part or a corner part of the housing viewed from a front side corresponding to the surface provided with the display; and
an information processing unit performing information processing based on an image obtained by the linear image sensor.

31. An information processing method for an information processing apparatus including a housing having at least one surface provided with a display, and a linear image sensor located, facing outside the housing, at a side part or a corner part of the housing viewed from a front side corresponding to the surface provided with the display, comprising:
obtaining an image by the linear image sensor; and
performing information processing based on the obtained image.
